(19) United States
(12) Patent Application Publication
(10) Pub. No.: US 2011/0276194 A1
(43) Pub. Date: Nov. 10, 2011

(54) SYSTEM AND METHOD FOR ENERGY MANAGEMENT

(76) Inventors: Hal A. Emalfarb, Highland Park, IL (US); David Swan, Tatamagouche (CA); Herman Glenn, Sun Prairie, WI (US); Scott Turik, Crystal Lake, IL (US)

(21) Appl. No.: 13/104,284

(22) Filed: May 10, 2011

Related U.S. Application Data
(60) Provisional application No. 61/333,092, filed on May 10, 2010.

(51) Int. Cl. G06F 1/28

(52) U.S. Cl. 700/297

(57) ABSTRACT

The present invention provides for multiple energy pooling stations to combine renewable energy, utility energy and back-up power services in the form of Green and Black Energy with energy storage to create a multi-income stream. An energy pooling station is an advanced part of an evolving “energy network” in which multiple energy pooling stations are communicating with each other to share energy credit, bank energy, and distribute the energy to customers.

### CROSS-REFERENCE TO RELATED APPLICATIONS

This application claims the benefit of US Provisional Application 61/333,092 and hereby incorporates the application by reference.

### FIELD OF THE INVENTION

The present invention relates to a system and method for maximizing the use of green energy by aggregating energy pooling stations that are in turn aggregated into an energy network that utilizes an algorithm for managing a controlled energy load, to optimize renewable energy and power sales.

### BACKGROUND OF THE INVENTION

The overriding consideration of the invention is to maximize economic return from embodiments of renewable energy pooling stations. Electrical energy is generated by different methods, e.g. coal and natural gas are low cost but environmentally damaging (referred to herein as “Black Energy” or “BE”) and solar/wind is environmentally friendly at higher cost (referred to herein as “Green Energy” or “GE”). Black Energy is generally available on demand, independent of the time of day or the day of the week. Green Energy is not generally available on demand and must be either used or stored as it becomes available. The sources of energy can be further defined as: on-site Green Energy (such as by Solar panels or wind turbines); grid Green Energy (remote wind field, hydro provided by grid); and grid Black Energy (coal, nuclear, oil, etc.). With the price of the Green Energy being based on bidding or long term contract, and availability. Price of Black Energy may also be based on time of day, day of week but has no normal availability issues

Also by way of background, the sale of power, (kW) is different than the sale of energy (kWh). Power must be made available for electric utility frequency regulation. A characteristic of this power market is that it net-zeros the grid energy used by demanding equally portions of positive and negative of power over a given period of time (typically one day). However, losses in the electronics and energy storage require make up energy, Green or Black. The Customers on the energy pooling stations can be defined as: an Energy Customer (a net user of energy such as the vehicle or property owners) and Power Customer (a zero net user of energy over some time period such as the ISO/Utility company).

### SUMMARY OF THE INVENTION

In accordance with the present invention there is provided energy pooling stations that are capable of producing, distributing, banking, exchanging for credit, and pulling/pushing energy. The energy stored in each station's energy pool may be in the form of renewable Green Energy and non-renewable Black Energy that can form the basis of a single pool of energy by each station that can aggregate its energy and power by being intelligently connected to other energy pooling stations in the local or remote energy network. The energy pooling stations may aggregate and communicate with each other to form an energy network that can exchange credits such that a station at one location can provide a customer with Green Energy when the station itself has no Green Energy available. A software management system is provided to monitor and calculate the exchanges, which can be based on the energy source, time of day, day of week, season, and/or weather. Revenues based on the invention are utilized in various ways, such as renewable energy sourced to charge the batteries of plug in vehicles; frequency regulation services provided by batteries integrated within energy pooling stations; uninterruptable and emergency power services to connect buildings/structures and bi-direction energy flow between participating connected electric vehicles to help meet charging deadlines, access stored power in participating energy pools to charge third party electric vehicles or all other loads within the energy network.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a diagram of an energy charging station in accordance with one embodiment of the present invention;

FIG. 2 is a diagram of a second embodiment of the present invention describing an energy pooling station and its stored power;

FIG. 3 is a diagram of an energy pool showing an aggregation and communication between multiple energy pooling stations.

FIG. 4 is a flow chart of an energy management method according with one embodiment of the invention;

FIG. 5 is a flow chart of calculation method setting forth details of step 4112 of FIG. 4; and

FIG. 6 is a flow chart of the Energy Network setting forth details of step 4114 of FIG. 4.??

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

The energy pooling stations combines' renewable energy, utility and back-up power services with energy storage to create energy pools earning multiple-income streams. The energy pooling station is an advanced part of an evolving “energy network” in which multiple energy pooling stations are communicating with each other. Some of the specific functions that can provide financial revenue streams are as follows:

Frequency Regulation Services—Provided to the ISO/Electric Utility by the Energy Storage and EPU, and controlled by Energy Manager.

Renewable Energy to Plugin Vehicles—Providing renewable energy from on site Wind, Bio-Mass, Solar Panels and/or grid purchased Green Power to provide energy and power to the energy pools connecting to charging stations that fuel private and fleet vehicle owners. The energy stations and the connected energy pools will be controlled and metered by the Energy Manager to facilitate customer billing, shift, reduce and otherwise on command efficiently manage controlled energy loads as required by the Energy Network algorithms and related software. In addition excess generated Green Power can be sold back to the grid.

Uninterruptable and Emergency Power—Providing lighting, electronics support, fire protection, etc. to the local customer. This can also provide support to Electric ISO/Utility during periods of brown-out and or black start-up. This would be controlled and metered by the Energy Manager to facilitate customer billing.

Broker of V2G Services—Providing the opportunity to participate Vehicle to Grid Frequency Regulation Services from plugged-in Electric Vehicles to private and fleet vehicle owners. This is controlled and metered by Energy Manager to facilitate customer billing shift, reduce and otherwise on command efficiently manage controlled energy loads as required by the Energy Network algorithms and related software.

Under the Frequency Regulation Services, ISO/Utility demand response is a high value service that supports short term electric utility load changes. Frequency Regulation is a Power Market with a net zeroing in energy. Demand Response is an all-encompassing term that includes power and energy markets. To accomplish this task requires energy storage and high quality bi-directional DC to AC power electronics. In most areas of the US and Canada, a Utility System Operator can provide an electronic signal to request frequency regulation, peak load shedding or relief on specific areas of the distribution system. The general characteristics of this service pertaining to energy pooling stations relate to many factors, including but not limited to: (a) the frequency regulation market is an hour-ahead market. Contracts are bid one day in advance. Bidding is accepted until the required MW capacity is reached. The final and highest bid sets the price for all bidders; (b) the ISO PJM energy market has a minimum Frequency Regulation contract of 500 kW, and the energy pooling stations will aggregate in energy pools as needed to comply with local ISO/Utility load requirements. Multiple, distributed energy pooling stations or units (e.g. twenty, 25 kW energy storage devices) can meet the contract requirement by responding to a centralized control signal; (c) the need for energy market frequency regulation is typically 1% of total demand (e.g. Utility has a 10,000 MW demand, need 100 MW of frequency regulation); (d) Frequency Regulation contract does not specify single or 3 phase regulation. The V2G EVs are grid connected by single phase. They can frequency regulate into 120 VAC (limit of 12 Amps) or 208/240 VAC (limit of 50 Amps); (e) the bid is based on power not energy. However, the power obligation in charge or discharge can last up to 15-20 minutes in any one hour. For a 10 kW offer, this means that the energy storage must be able to provide or absorb 2.55 to 3.33 kWh at any time during that hour; (f) power signal received and acted upon every 4 to 5 seconds; (g) it is estimated that 20% of bid 10 kW is the actual average power requirement; and (h) net energy zeroing is over a 24 hour period.

Others have experimented with vehicle to grid (V2G) charging. The V2G, E box electric vehicle is normally plugged into 208 VAC with a ±10 kW limit. The battery has a name plate of approximately 35 kWh. This translates to an energy to power ratio of 3.5 and subject to increase/decreases as power is measured by the signal and the power capacity sent/received into the ISO/Utility market. Based on operating experience, the energy storage is adequately sized for the power capability. The V2G work is associated with the AES frequency regulation trailer. This trailer has a 1000 kW power capability and a 250 kWh Li based battery. This translates to an energy to power ratio of 0.25. Based on operating experience the energy storage is undersized for the frequency regulation power capability. The single-phase frequency regulation created by multiple E box EVs, energy pooling stations and energy pooling or stations in remote areas is acceptable. It is expected that the energy pooling concept spreads the natural distribution on the phases and the large size of the system may necessitate 3 phase grid connections. The E box control signal for V2G is via a signal superimposed on the AC power line. The signal is carried over the same 2 wires as the power, in the form of a high frequency 5V signal riding on top of the 60 Hz, 120/240V power. The interface is a TrendNet TPL-202E: one is placed in each car and one behind each plug. Each unit is separately addressed. When a V2G vehicle is connected to the energy pooling instillation it's V2G controls are connected not the grid, but to the manager which then updates its energy pool info with the ability to sink/source more power via the V2G equipped vehicle.

Under Renewable Energy to Plug-In Vehicles—renewable energy can be sold to environmentally conscious plug-in vehicle owners. The renewable energy is made on site from solar panels, transferred from other energy pooling stations or purchased from the grid by a certified provider. In any case, energy storage is used to facilitate the issues of real time green energy, or other renewable power availability and time of use rates. Expected early adopter vehicles that would use energy pooling stations would include: GEM as a Level 1 Charging; Plug-In HEVs as a Level 1 Charging; Think City/GM Volt/Nissan Leaf as a Level 1 and Level 2 Charging (<4 kW AC).

The energy cost of recharging an electric vehicle is substantially less than an equivalent gasoline vehicle (20 to 70%). As a result, it is expected that environmentally conscious electric vehicle owners may be willing to charge their batteries to facilitate convenient and high profile Green Energy from local or remote energy pools

Under Uninterruptable and Emergency Power Services—the energy pooling station can provide a combination of uninterrupted and emergency power to local customers for lighting, electronics support, fire protection, etc. The power during grid failure is directly supported by the energy storage and power electronics unit. Renewable energy replacement and V2G will also extend the availability of local power during grid failure. It is also possible for the energy pooling stations to provide support to the Electric Utility during periods of brown out and or black start-up. These features are controlled and metered by an energy-pooling manager.

Under a Broker of V2G services—V2G vehicles become available, the energy pooling stations will provide private and fleet owners the opportunity to participate in frequency regulation services. Any vehicle based on the ACP technology (E box, Tesla Roadster and Model S sedan, BMW Mini E) can be used, and other technologies are expected to enter the market place.

The simultaneous functions of providing electric utility demand response and electric vehicle charging by green energy will be physically limited by the hardware. Critical to assessing these limitations will be field data and experience resulting from energy pooling stations.

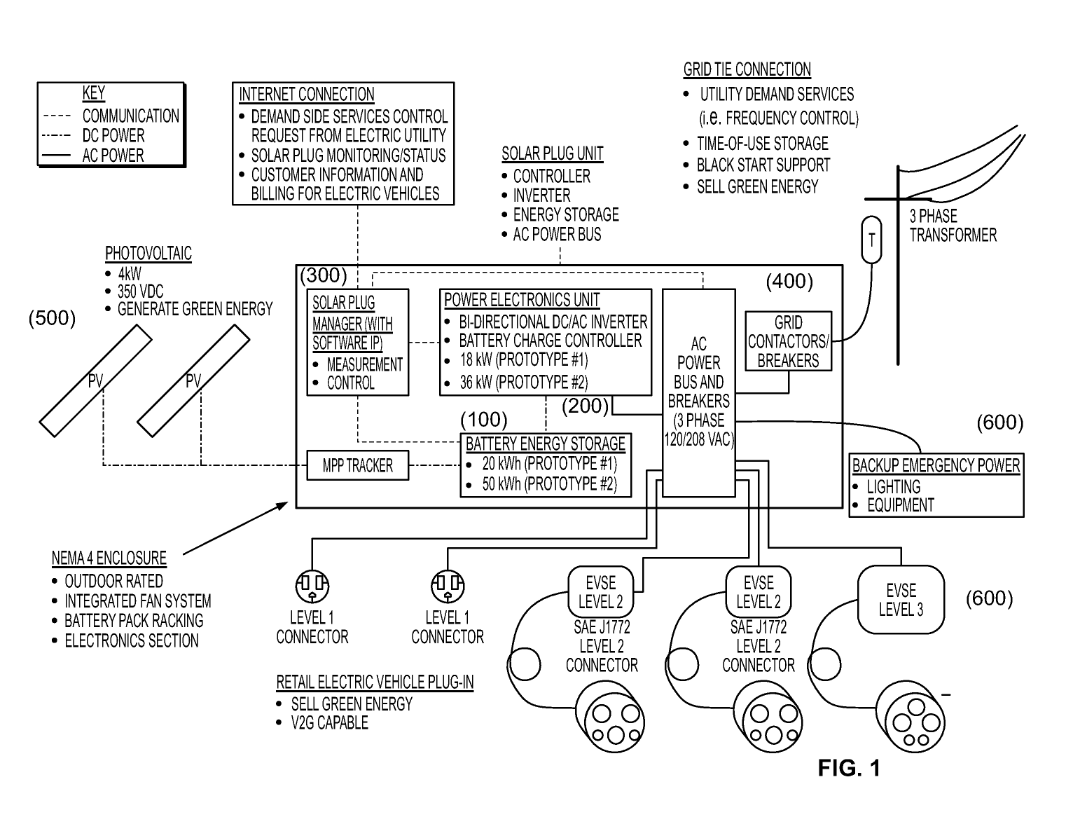

Referring now to FIG. 1, there is shown an energy pooling station in accordance with one embodiment of the invention.

The energy storage unit 100 is provided with a nominal 360 Volts DC. The chemistry of the batteries can be PbA Gel electrolyte to help for long life and low cost. The units can have manage the thermal heat and vent by an air exchange. The energy storage unit 100 is in communication with the power electronics units 200, the energy-pooling manager 300, and the renewable panels 500.

The power electronics units 200 controls the bi-directional DC/AC inverter and battery charger controller. Various other functions can also be detected such as ground fault and grid failures.

The energy pooling manager 300 measures and controls the green and black energy usage, consumption, generation, and credits. The Energy Network will offer Green Energy as the first resource of energy and supplemented by Black Energy dependent on demand and costs. The manager 300 independently monitors and manages battery storage State of Charge, State of Power, and battery State of Health The Energy Network will monitor and report customer billing based on the usage, consumption, generation and credits. And is capable of determining in real time decisions to accommodate expected renewable input and utility service requirements and can make considerations for the time of day, day of the week, season and weather in its determination of whether green or black energy is available. As illustrated and discussed herein below managers in multiple energy pooling stations are capable of communicating with each other over either a dedicated intranet or the internet, and may be wired or wireless communication.

The manager 300 includes software configured to provide direct measurements of PV/Wind/Renewable voltage/current; Battery voltage pack at ⅓, ⅔, etc positions; Battery current; Battery temperature; MPPT current (DC); PEU current (DC); Grid interconnection AC (power, voltage, current, power factor); and Vehicle interconnections AC (power, voltage, current, power factor). The software would be further configured to calculate Amp-hour depletion (SOC); Amp-hour throughput; and Power available.

The manager 300, battery energy storage devices 100, and the power electronics unit 200 would be placed in an enclosure or underground vault that further held AC power bus and breakers and grid contactor breakers 400. The grid contactor breakers 400 would connect to the utility grid and most likely to a 3-phase transformer.

Renewable panels 500 (such as thermal, wind, hydro, solar) provides local renewable energy. In one aspect there can be provided solar panels with a 1 kW rated power per parking spot. e.g. 4 parking spots 4 kW total, with an expected daily Energy of 4 kWh per day per 1 kW rating and a maximum Array OCV<600 VDC.

Energy is provided to vehicles via plugs 600 and to buildings through the smart panels. Various levels are provided such as level 1 plug 120 VAC 20 Amp circuit with GFI in weather proof housing; and Level 2 plug 208-240 VAC 40-80 Amp (such as specified by SAEJ1772 connector); and Fast Charging EV plugs to supply DC power

The energy pooling station is optimized for low cost by the use of in-production, high volume components where possible. The energy storage unit is a critical part of the energy pooling station, providing a source and sink for both energy and power as necessary. As the energy pooling station is a stationary application, battery pack choices include lead acid Lithium Ion, Zinc Bromide and other chemistries. Utilization of “second life” electric vehicle batteries is also possible.

During frequency regulation there are energy losses associated with the power electronics and batteries. In ideal frequency regulation, the electrical utility commands will zero net energy. However, the losses will result in a need for energy make-up. The following analysis is to quantify the daily make-up energy. For example if round trip efficiency during frequency regulation is 81% (inverter 95% each way, battery in/out 90%, (0.95)×(0.90)×(0.95)=0.81 The Energy losses during frequency regulation must be recovered by kWh purchase at the grid or by energy pooling station renewable input, such as by solar, wind, and other renewable sources such as hydro, etc. Using a 20% average, hourly power (20% of 18 kW) 1.8 kWh of energy cycled through the battery pack during the hour. This means a recovery of 0.34 kWh per hour or 8.2 kWh/day. The renewable solar is expected to provide 16 kWh per day. This can provide all of the losses associated with the frequency regulation and charge the batteries 7.8 kWh.

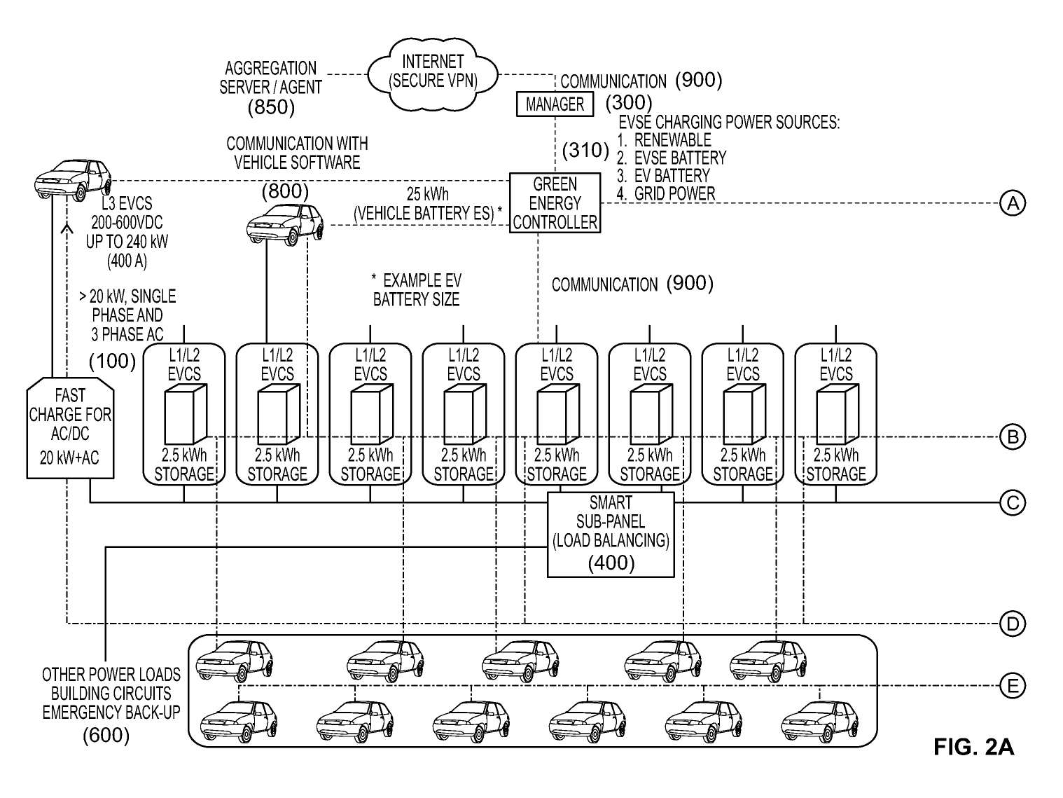

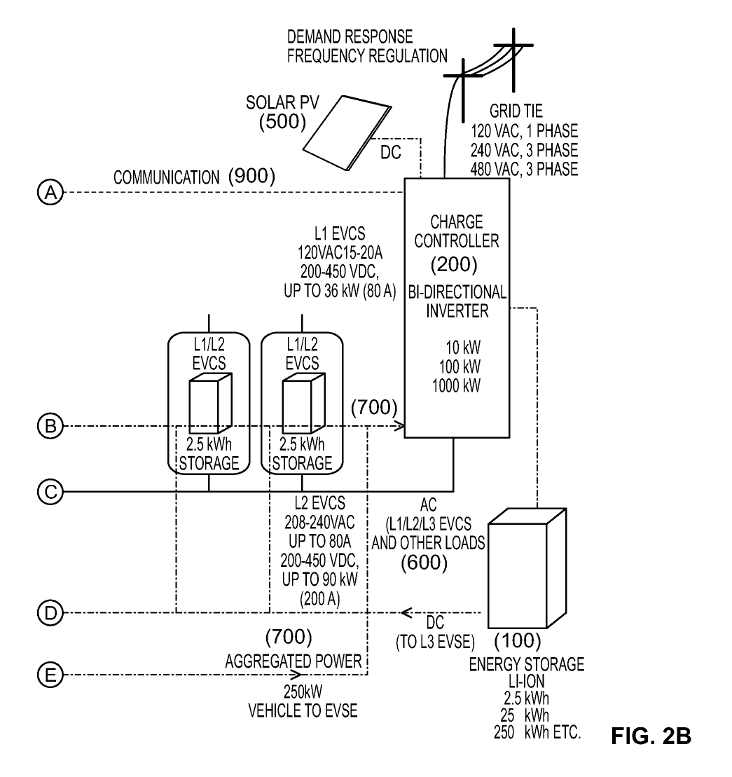

Referring now to FIG. 2 and used in conjunction with FIG. 1, there is shown a second embodiment of the present invention describing an energy pooling station and its stored power. As illustrated, the aggregated energy storage 100 is shown connected to a bi-directional power electronics unit 200 and is capable of enabling a frequency regulation revenue stream. The manager 300 has communication capability to control and monitor functions with both aggregated energy storage units and the power electronics unit. The power electronics unit supplies power to a smart breaker panel 400 connected to Level 1, 2 and Fast EV Charging Stations (EVCS) and other power loads (building circuits, etc.) 600 by converting energy from aggregated energy storage and other renewable energy sources such as photovoltaic solar panels, wind, thermal, and hydro 500, thereby effectively buffering the commercial power grid from EV battery charging and periods of peak demands while enabling the ability for consumers of power/loads 600 to be supplied with energy (renewable, stored renewable and recycled power, grid) from different sources that distinguish themselves both in terms of cost and generation methods, as well as supplying power loads with emergency power in the event of grid emergencies and power outages. In the use of this embodiment aggregated energy, from EVCS battery storage 700 or from EV batteries 800, is used to supply power to either other vehicles, to the grid via the power electronics unit for frequency regulation services, the grid for ADR participation, or to other local AC loads via the power electronics unit and smart breaker panel. The Manager 300 in conjunction with the Green Energy Controller 310, which may be software based, includes functions and the configurations to communicate total aggregated energy storage available at a given location to station command and control centers 850 which both monitors station operational status and provides information to energy markets and consumers. The Green Energy Controller is further configured, as detailed below, to control and facilitate the flow and availability of power from aggregated energy sources and EV batteries to other components based on availability, consumer preference and/or revenue potential.

In a further reference to FIG. 1—one embodiment of the invention consists of an energy pooling energy station 100, 200, 300 consisting of batteries, flywheel, air compressor or other energy storage technologies 100 as shown connected to a bi-directional Power Electronics Unit 200 enabling access to the electricity markets including but not limited frequency regulation markets. The Manager 300 has communication capability to control and monitor functions pooling energy through the Controller 310 by a bidirectional flow of electricity provided by the intelligent Power Electronics Unit 200. The Power Electronics Unit 200 supplies power to a Smart Breaker Panel 400 connected to Level 1, 2 and Fast EV Charging Stations (EVCS) and other power loads (building circuits, etc.) by converting Green Energy or Black Energy from pooled energy stations including renewable energy sources such as but not limited to photovoltaic solar panels 500, thereby effectively buffering the commercial power grid by controlling the EV battery charging loads and load shifting during periods of peak demands while enabling the ability for consumers of power/loads 600 to be supplied with Green Energy (renewable, stored renewable and recycled grid power) from different sources that distinguish themselves both in terms of cost, storage and generation methods, as well as supplying energy loads with emergency power in the event of grid emergencies and power outages. FIG. 2 will thus illustrates an example of the use of this invention for the purposes described above and provides further detail of the stored pooled Green Energy and Black Energy functionality. Pooled energy stations provide the EVCS loads with energy storage 700 from lithium ion or other types of batteries, or other energy storage such as flywheel, air compressor, etc and all types of batteries 800 which is used to supply power to either provide the power to charging stations to fuel other vehicles, to connect the energy pooling stations to the grid via the Power Electronics Unit 200 for connecting to the ISO/Utility markets such as frequency regulation services, or to supply power and energy to other local AC loads via the Power Electronics Unit and Smart Breaker Panel. The Manager 300 in conjunction with the Controller 310 functions to communicate total pooled energy storage available at a given location to station command and control centers 900 which both monitors station operational status and provides information to energy markets and consumers. The Controller 310 functions [as described elsewhere in this patent] to control and facilitate the flow and availability of power from pooled energy stations, and from/to EV batteries to other intelligent power electronic inverter components 200 based on availability, consumer preference and/or revenue potential.

One of the major pieces required to make the new smart grid effective is a buffer in the system that can store or pool energy to balance the whole smart grid system. The need to buffer adverse impacts of the rapidly increasing penetration of renewable energy resources, helping serve electric utilities through our energy pooling invention that benefits load shifting and fosters the bidirectional flow of electricity through the grid-tied energy storage systems. Smart-grid technologies also help to aggregate and control distributed storage units as a highly responsive and flexible fleet.

Energy Pooling Stations play key roles in the new decentralized grid: Energy Storage—The energy pooling station 100 200 300 is acting as a fuel tank for Green Energy and Black Energy. Energy Dispatch—Power generation coupled with storage makes energy available when needed, independent from the actual time of generation. Supply and demand for power can be separated by as far as capacity of the energy storage unit allow; Balance—Energy storage 100 compensates for the intermittent nature of renewable energy sources and can bridge ramp-up/down periods between different loads and power generation modes; Power Stabilization—Energy storage performs an important power quality function through the inverter components 200 by providing voltage stabilization/compensation on a standby basis while also providing permanent regulation services.

By adding energy pooling stations to help control power loads and increase efficiency in delivering power and energy to the grid the energy pooling station adds capacity to the flow of energy to the EV charging station coupled with utility scale stationary storage, the Electric Vehicle Supply Equipment (EVSE) coupled with energy storage itself becomes both a grid buffer (load shifting) and the enabler of additional value-added applications. This invention increases the benefit of adding an energy pooling station infrastructure to buildings and public spaces by both reducing the cost of new generation of electricity, and at the same time makes EVSE more compatible with power-grid operational requirements. Applications include but are not limited to using EVSE storage to buffer energy produced from photovoltaic (PV) or other renewable sources and vehicle to vehicle electric power transfers.

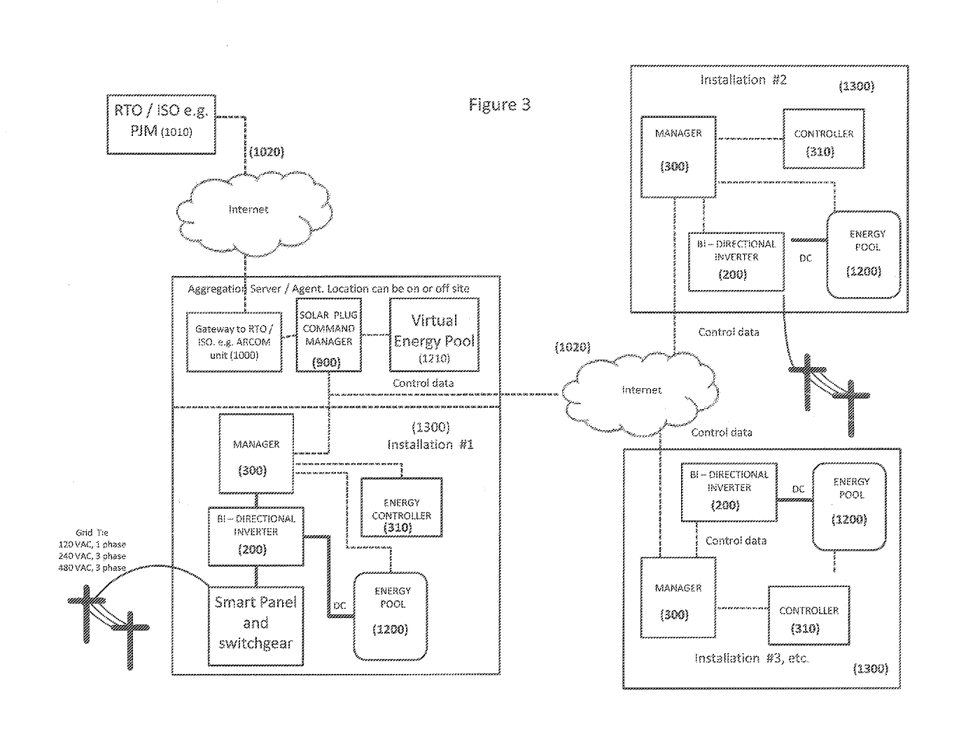

With further reference to FIG. 3 there is shown an aggregation and communication of multiple energy pooling stations or installations which share information and share energy and power over an energy network. As illustrated there is described one possible manner in which energy pooling stations 1300 are interconnected and configured to provide grid frequency regulation service (“Grid FRS”). The Grid FRS commands are sent over a communications channel 1020 from the Grid Regional Transmission Operator (“RTO”) or Independent System Operator 1010 to the energy pooling station 1300. One possible way to receive the FRS messages is to have a dedicated gateway 1000 supplied by the RTO. The gateway will send and receive grid regulation service messages to and from the Manager 310 to the RTO. The manager software monitors energy and power sources available to it and sums them to generate a virtual energy and power pool 1210. The summed pool of the available power resources is what is used to do grid FRS. Using the summed pool, the manager will dispatch power generation and consumption commands via a communications channel 1020 to other managers 300 in order to meet the RTO FRS commands. The communications channel 1020 can be of any form as long as a minimum response time is maintained. A data link monitor service should be run to monitor the link status for fault protection

The local energy pool 1200 of each energy pooling station or instillation can be dynamic in nature. With some forms of energy storage and power generation/consumption entering and exiting the pool at any time. The manager software may choose to include variable resources into its local energy pool. Such resources as V2G enabled vehicles or bi-directional DC power links to connected vehicles may be used to augment the pools available power and energy quantities. It may also take into account the ability to dynamically control building loads via a connected smart panel. As described below another aspect of the Manager 300 for the energy pooling station or the energy pools is it's tracking of Green Power vs. Black power. With this information tracked for each energy pool in the energy network, including the virtual energy pool. The command manager 900 has the ability to choose which kind of power is delivered to the grid for FRS. Information relating to the type of energy or power being provided to the energy pooling stations is easily accessible from the grid. Therefore, the local or command manager will be able to track and determine the amount of Green Energy/Black Energy it has at its disposal, has used in a given time period, or has amounts of credits.

Local energy pool information may be generated from historic data, time of use information, or connected device profiles. An example of how the local manager software would handle a connection to its local energy pool. In a first scenario embodiment, a J1772 Bi-Directional DC fast charge compliment vehicle may connect to a local energy pool 1200. The vehicle profile has a time of departure set for 7 hours in the future, and a desired final SOC at departure of between 80%-100%, the starting SOC is 20% and the vehicle profile is set to allow participation in a demand response application. The vehicle is assumed to come into the system with ‘Black Energy’ unless it can tell the Manager 300 otherwise. The Manager 300 would then increase its energy pool capacity by the amount of the newly connected vehicle pack, and update the local energy pool energy mix numbers with the additional 20% of BE stored in the vehicle. If the vehicle DC link also generated a change in the total power ability that would also be reflected in the local energy pool. The local manager may also prioritize vehicle charging based on factors such as expected time of departure, current SOC, expected charge rate, and time tell full.

The Virtual Energy and Power Pool is used for determining the ability of the energy network to participate in the automated demand response and all other electricity markets. The locale storage and generation devices are aggregated to form the local energy pool 1200. The local energy pool may contain vehicle batteries and other energy storage devices such as: flywheels, compressed air, flow batteries, local batteries distributed in the energy pooling stations and energy producing devices such as wind, solar, geothermal, hydro etc. The energy is tracked in each storage device by the manager, allowing a guarantee of energy, and its type (Green or Black). Again as with FRS the local energy pools are aggregated together to generate a Virtual Energy Pool 1210 used by the Command Manager 900 to absorb or generate power for the Automated Demand Response/Reduction: (“ADR”) market. The Virtual Energy Pool will be analogous to the ADR term “Spinning Reserves” as it reflects the ability for the energy pooling stations to provide ADR services in the same manner.

The ability of the energy network to handle ADR requests at a distributed level, for example prioritizing its charging and local storage based on time of day and grid excess power sets this implementation apart from others. It can “bank” Green Energy while grid output is high and, even when in an demanded reduction state provides charging to its customers due to its “spinning reserves”. This also allows the energy pooling stations to shift power through the grid from one instillation to another to maintain a Green Energy guarantee or demand for its customers.

Data communication between energy pooling stations (1300) may be of any types such as wireless data connections like, but not limited to, GPRS, Wi-Fi, WiMAX, HSPA, EVDO, LTE. Or wired network data connections such as Ethernet, HomePNA, ISDN, Prime or G3 PLC, PON. Internal to any energy pooling station may include any of the above networks used to connect the manager to devices participating in its local energy pool.

The energy pooling stations are scalable and can be integrated with any size RTO/ISO from trans-country RTO's down to small local utility companies. It provides a convenient way to add Green Energy to the power grid and store Green Energy surpluses. Also, the aggregated energy network provides a single point of ADR control for RTO/ISO's and local utilities to interface with. The aggregation features of the energy pooling station's energy network also can be used to help offset load peaks generated by industrial or consumer customers. The energy network can absorb Green Energy from the grid when it is at a surplus and hold it in the distributed energy pools. Then through the use of this banked Green Energy the energy network can supply Green Energy to a customers even when there is no Green Energy available on the power grid, moving the energy through the energy network.

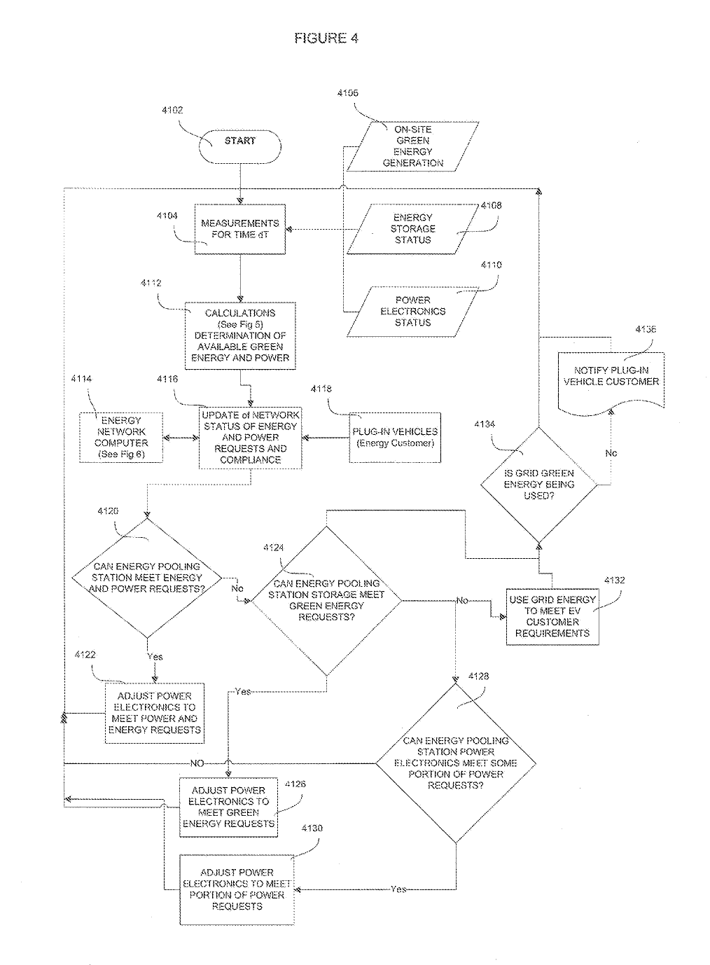

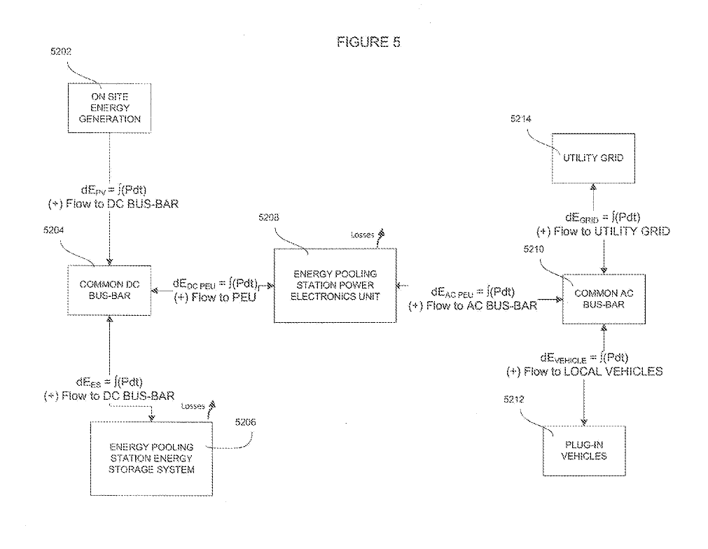

With reference to FIG. 4, there is shown a method in accordance with one embodiment of the invention and is directed to an energy pooling station control overview. The method starts at step 4102 and proceeds to step 4104. The algorithm first measures the on-site Green Energy generation 4106, energy storage status 4108, and power electronics status 4110. The energy storage and power electronics status includes power flows as outlined in FIG. 5 and physical limits of the equipment such as design capability, and temperature limits. The measured values are averaged over a short time period to provide and accurate integration of energy transfers between components. The step 4112, calculation determines the energy storage and power electronics available capacity and capability at current rates of use. Communications, step 4116 are made to local plugged-in electric vehicles, step 4118 and the energy network, step 4114 to provide local status and requests from the network to assist in meeting remote energy power and energy customers. Requests can be made of the energy network for Green Energy credits to meet local energy pooling station requirements.

The following decision step 4120, compares energy and power requests with the energy pooling station capability. This will consider the time period over which the requests are being made. If all requests can be accomplished, step 4122 the power electronics are adjusted accordingly. If both power and energy requests cannot be met, the algorithm transfers to decision step 4124. In step 4124 the Green Energy requests from the energy storage are considered and if adequate the power electronics, step 4126 are adjusted. If the Green Energy requests cannot be met by the energy storage, the algorithm transfers to steps 4128 and 4132. In step 4128 a portion of the power request is considered and implemented by the power electronics in step 4130. In step 4132, grid power is utilized to meet EV customer requirements. In decision step 4134 the grid power is compared to available Green Energy credits and if inadequate the customer is notified in step 4136. The algorithm separates the Green Energy from Black Energy and keeps a separate account for losses.

FIG. 5 shows the calculations to determine the status of the energy storage, 5206 and power electronics, 5208. By considering the energy flow from the onsite solar generation 5202, the utility grid, 5214 and the Plug-In vehicles the energy conversion at the power electronics, 5208 and energy storage, 5206 can be calculated. Losses associated with these conversions are used to determine net energy stored and transferred.

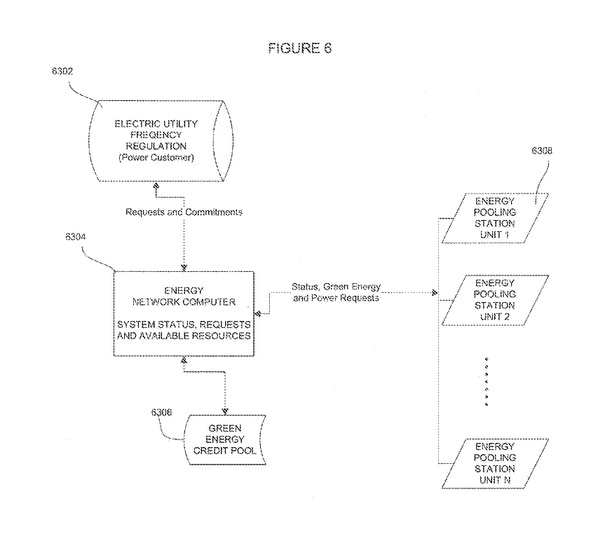

FIG. 6 shows the individual energy pooling stations 6308 communicating with the energy network computer, 6304. The network computer maintains historical operational information for the system and individual energy pooling stations. It maintains the system status and a pool for Green Energy Credits, 6306. The Green Energy credits may be generated at individual energy pooling stations or purchased from offsite grid suppliers. Green Energy credits are provided to individual energy pooling stations to meet Green Energy request that cannot be met by the energy storage. FIG. 6 also shows the electric utility frequency response requests and commitments in step 6302.

As utilized by the energy pooling stations for one or more embodiments herein there is provided an algorithm software component configured to monitor and control the Green and Black Energy. The algorithm's primary function is to match customer need, generation source, and energy pooling station's physical limits. Using the described algorithm, it is possible to serve these functions using a single energy storage system for both Black and Green energy and a single power electronics unit. One aspect is an algorithm that will recognize and control the relative quantities of Black and Green Energy that is being used in charging and discharging the energy storage system. This is essentially an accounting and control concept that responds interactively to energy source availability, customer demand and the limits of energy pooling installations.

Aspects of the software include the configurations to one or more of the following:
(a) use the energy store for maximum quantities of Green Energy. Black Energy is acquired as needed directly from the grid;
(b) use an accounting method to “bank” Green Energy and transfer Green/Black Energy credits between energy pooling stations for the account of Power and Energy Customers;
(c) recognize that some customers are energy related while others are power related. This distinction is very important as a Frequency Regulation customer will net zero the energy to meet changes in power. The energy pooling stations however, will accumulate significant internal losses during the ±energy storage and ±energy conversion (AC to DC to AC). These losses are attributable to the frequency regulation customer (Black Energy customer). By replacing these losses with Green Energy, the energy pooling station's energy storage capability is effectively expanded because the replaced losses can later be substituted with Black Energy for a Green Energy sale;

(d) recognize that internal losses during energy conversion may be different from the type of electricity being provided to the customer. For example, a charging EV that requires 10 kWh of Green Energy delivered to the vehicle may require 11 kWh from the energy storage. The 1 kWh difference is due to losses. This loss could be balanced by Black Energy from the grid, providing the EV customer with 100% Green Energy while minimizing the cost of the internal losses associated with delivering that electricity.

Furthermore, since the energy Network is multiple energy pooling stations, a network computer maintains Green Energy credits generated by the individual stations or purchased over the grid. The network computer also receives frequency regulation and other electricity market requests as may be applicable such as demand response, capacity markets, etc from the ISO/Utility and dispatches commands to the individual energy pooling stations based on power electronics availability.

The tasks conducted by the energy pooling stations are conducted, not in any particular order as outlined herein, but preformed as one or more of the following:

One, EV charging for an energy sale ($/kWh) sources the energy by Green Energy using Black Energy for banking and to account for energy pooling station losses. The Green Energy is sold at to be determined market prices and Black Energy is customer option at to be determined market prices. The Black Energy can be sold and the Green Energy can be banked and later replaced to the power grid as Green Energy. The Green Energy credit accounting is maintained by an energy network computer, which manages the energy across multiple energy pooling stations.

Two, Frequency Regulation—for a power sale (S/kW) sources the energy at a net-zero to the customer and uses if Green Energy is unavailable or if Black Energy is selected to cover energy pooling station losses. This aspect or task net zeros energy every 24 hour period, Black Energy is used to cover energy pooling station operating losses and any Green Energy used to cover these losses is banked.

Three, V2G For Frequency Regulation—for a power sale ($/kW) sources the energy at a net-zero to the customer and uses Black Energy to cover energy pooling station losses. This task net zeros energy every 24 hour period, Black Energy is used to cover energy pooling station operating losses and any Green Energy used to cover these losses is banked.

Four, Uninterruptable and Emergency Power—for an energy and power sale ($/kWh and $/kW) sources the energy from Back Energy by using stored Green Energy that is banked for future use from Black Energy sources. The user of the uninterruptible power supply task is Black Energy as opposed to on-site diesel generation. The stored Green Energy can be sold at a high Black Energy price because the grid is not available and later banked back using Black Energy.

Five, Energy Customers will be connecting their energy needs as building owners for example, and having the software determine peak uses and where Green Energy can be used and when Black Energy can be used to maximize environmental and/or cost benefits as selected by the Customer.

Various features of the software used will now be discussed. Accumulation and Accounting—The software may be configured to distinguish between Green Energy, Black Energy and Energy Losses associated with energy storage and energy conversion. The State of Charge (accumulated energy storage) is the integration of these energy flows. The software maintains separate integrators for each value.

Energy and Power Customers—the software may further be configured to distinguish between energy and power customers. An energy customer is a net user of energy. A power customer temporarily uses energy to satisfy a short-term power requirement. Excluding energy pooling station losses, the net energy usage of a power customer is zero.

The energy storage (“ES”) use is determined by the Customer—the relative use of the energy storage capacity is determined by the power and energy customer requirements. The energy storage capacity is assigned a specific SOC operating range for energy customers, e.g. 20 to 80%. The remaining 0 to 20% and 80 to 100% is available to power customers for sourcing and sinking power as required. There is typically a 15-20-minute power requirement for frequency response. The energy required to meet this power requirement represents 20% of the ES capacity.

Losses are Irreversible (heat)—to maintain a specific energy storage State of Charge, the software may further be configured to recognize that the energy pooling station's energy storage and power electronics accumulate local energy losses due to their function, the software is configured to choose whether to replace the losses by additional Green or Black Energy.

The ES only Accumulates Green Energy—the software may further be configured to net increase the ES accumulation by Green Energy. If the ES SOC is low, power requirements are met by Black Energy. Black Energy will only be stored temporarily (24 hours) for power customer use only—20% of ES SOC.

The Banking of Energy Pooling Station's Losses—the software may further be configured to choose Green Energy “banking” the losses and later exchanging Black Energy for the Green credit. For example, using on site Green Energy to cover losses when available, using Black Energy later as supplement during a Green Energy sale, which effectively exchanges the banked losses to Black Energy.

The Banking of Green Energy, Black Energy, and Losses Between Energy Pooling Stations—through communication with other energy pooling stations and remote energy pools the software may further be configured to exchange Green Energy to losses account values. Analogous to this, is a financial wire transfer between financial institutions. The exchange is accomplished by a) utilizing remotely banked Green Energy losses for local Black Energy, and b) utilizing remotely stored green energy in the grid.

The software may further be configured for different modes of operation for energy pooling stations. These include (a) charging of EVs with the priority of energy supply being up to 80% of the Storage Capacity; and (b) frequency response—priority of power supply. In Charging EVs, the priority is defined by first using on site Green Energy; second, using grid supplied Green Energy; third, energy source supplied as Green Energy to 20% SOC; fourth, grid supplied Black Energy based on the energy pooling station's banked Green Energy (using on-site and then taking from off-site energy pooling stations); and lastly, using grid supplied Black Energy—when the customer has been informed that Green Energy is not currently available.

In Frequency Response, the power electronics will be commanded to ether absorb or provide power to the grid. The absorbing of power requires a dedicated allocation of energy storage capacity to be able to store the temporary energy for later use, e.g. 80 to 100% State of Charge. In an extreme case, if the energy storage allocation is exceeded (>100%) the power can be dissipate in a common resistor bank. The providing of power requires a dedicated allocation of energy storage capacity to be able to provide the temporary energy, e.g. 20 to 0% State of Charge. In an extreme case that the energy storage allocation is exceeded (<0%) the power may obtained by ceasing EV charging, effectively providing power by removing load.

In addition, the software yet may be further configured to one or more of the following: (a) integrate on-site green power production to determine the on-site green energy; (b) calculate grid supplied energy type—Green and Black; (c) determine the energy storage charge state (Green+Black Charge State=Total State of Charge); (d) calculate losses due to I²R (in the power electronics); (e) calculate losses due to I²R (in the energy storage based on a function of the temperature); (f) integrate Green Energy in storage to determine Green State of Charge; (g) integrate Black Energy in storage to determine Black State of Charge; and/or (h) integrate Green and Black Energy to determine total State of Charge.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A method utilized by an energy pooling station, wherein the energy pooling station has a renewable energy generator for generating Green Energy, has a connection to a power grid for receiving Green Energy and Black Energy, wherein Black Energy is defined as being created by a non-renewable energy source, has storage facility for storing Green Energy for allocation and use and includes vehicle charging plugs for connecting a vehicle to the energy pooling station, the method comprising the steps of:
measuring on-site Green Energy/Green Power generation;
calculating available Green Energy/Green Power at a current rate of use;
comparing a request for Green Energy and Green Power made at the energy pooling station by a customer with the Green Energy/Green Power available at the energy pooling station;
upon determining that the request for Green Energy/Green Power made at the energy pooling station can be meet, adjusting an allocation of the storage of Green Energy and Green Power storage to meet the requests;
upon determining that the Green Energy and Green Power requests made at the energy pooling station cannot be meet, adjusting an allocation of the storage of Green Energy and Green Power storage to meet a portion of the requests and utilizing grid power and energy to meet a remaining portion of the requests; and
when grid power is utilized, comparing Green Energy credits available to the energy pooling station and notifying the customer if Green Energy/Green Power is not available.

2. The method of claim 1, wherein the measuring of on-site Green Energy generation includes storing a status of Green Energy storage for a predetermined time and storing a status of Green Power storage.

3. The method of claim 3, wherein the step of calculating available Green Energy/Green Power includes averaging the measured values over a predetermined period to account for integration of energy transfers between components.

4. The method of claim 1, wherein the step of comparing energy and power requests includes a determination of available Green Energy/Green Power based on one or more of the following: time of day, day of the week, season, and weather.

5. The method of claim 1 further comprising communicating with an energy network for sharing Green Energy/Green Power information with at least one other energy pooling station.

6. The method of claim 5 further comprising using a Green Energy credit available by said other energy pooling station to meet the request for Green Energy/Green Power at said energy pooling station.
